(19) United States
(12) Patent Application Publication
(10) Pub. No.: US 2016/0150207 A1
(43) Pub. Date: May 26, 2016

(54) SOUND SIGNAL PROCESSING METHOD AND APPARATUS, AND MOBILE TERMINAL

(71) Applicant: Sony Corporation, Tokyo (JP)

(72) Inventor: Jiajia ZHENG, Beijing (CN)

(21) Appl. No.: 14/649,418

(22) PCT Filed: Jan. 22, 2015
(86) PCT No.: PCT/IB2015/050480

§ 371 Date: Jun. 3, 2015

(30) Foreign Application Priority Data
Jun. 24, 2014 (CN) 201410286346.2

(51) Int. Cl. H04N 9/806; H04S 7/00; H04R 1/40; H04R 5/04; H04N 13/00; H04R 3/00

(52) U.S. Cl. CPC H04N 9/806; H04N 13/0055; H04R 3/005; H04R 1/406; H04R 5/04; H04S 7/302; H04R 2430/01; H04R 2499/11; H04S 2400/15

(57) ABSTRACT

The embodiments of the present disclosure provide a sound signal processing method and apparatus, and a mobile terminal. The sound signal processing method includes: acquiring an image signal by using an image collecting member; acquiring sound signals by using at least two sound collecting members; acquiring state information of a mobile terminal by using a state sensing member; and processing the sound signals acquired by the at least two sound collecting members according to the state information of the mobile terminal, when the image collecting member acquires the image signal. Through the embodiments of the present disclosure, the sound signals from different sound collecting members can be controlled dynamically, thereby obtaining a good stereo shooting effect and improving the user's experiences.

### CROSS REFERENCE TO RELATED APPLICATIONS

Priority is claimed from Chinese patent application No. 201410286346.2, filed Jun. 24, 2014, the entire disclosure of which hereby is incorporated by reference.

### TECHNICAL FIELD

The present disclosure relates to a sound signal processing technology, and particularly, to a sound signal processing method and apparatus, and a mobile terminal.

### BACKGROUND ART

Currently, some mobile terminals have the function of camera shooting, such as a mobile communication terminal (cellular phone), a camera and a tablet PC which have the function of camera shooting. The user can shoot videos and images by using camera elements disposed in those mobile terminals, and collect sound signals by using sound signal collecting members (e.g., microphone) disposed in those mobile terminals.

To be noted, the above introduction to the technical background is just made for the convenience of clearly and completely describing the technical solutions of the present disclosure, and to facilitate the understanding by a person skilled in the art. It shall not be deemed that the above technical solutions are known to a person skilled in the art just because they have been illustrated in the Background section of the present disclosure.

### SUMMARY

However, the inventor finds that the existing mobile terminals usually have 1 or 2 microphones, and the settings of the microphones are the same for processing the sound signals. When collecting videos with the mobile terminal, the user often needs to continually adjust a shooting position or a shooting angle to obtain a better video effect. But the microphones with the same setting cannot adjust the processing of the sound signals along with the variation of the position or angle, thus the effect of the collected sounds is usually unsatisfactory.

The present disclosure provides a sound signal processing method and apparatus, and a mobile terminal, which can dynamically adjust the collected sounds during the video collection, thereby obtaining a very good sound effect.

According to a first aspect of the present disclosure, a sound signal processing method is provided, including:

acquiring an image signal by using an image collecting member;
acquiring sound signals by using at least two sound collecting members;
acquiring state information of a mobile terminal by using a state sensing member; and
processing the sound signals acquired by the at least two sound collecting members according to the state information of the mobile terminal, when the image collecting member acquires the image signal.

According to a second aspect of the present disclosure, the sound signals acquired by the at least two sound collecting members are processed independently from each other.

According to a third aspect of the present disclosure, the state information of the mobile terminal includes translation information and/or rotation information.

According to a fourth aspect of the present disclosure, the state sensing member is an accelerometer, and the state information acquired by the accelerometer includes linear acceleration information and/or angular acceleration information.

According to a fifth aspect of the present disclosure, processing the sound signals acquired by the at least two sound collecting members according to the state information of the mobile terminal, includes:

performing a gain control for the sound signals acquired by a part or all of the at least two sound collecting members according to the state information of the mobile terminal.

According to a sixth aspect of the present disclosure, performing a gain control for the sound signals acquired by a part or all of the at least two sound collecting members according to the state information of the mobile terminal, includes:
increasing the gain of the sound signal acquired by a sound collecting member closer to a first direction among the at least two sound collecting members, when motion state information of the mobile terminal is translating towards the first direction; or

decreasing the gain of the sound signal acquired by a sound collecting member closer to a second direction among the at least two sound collecting members, when the motion state information of the mobile terminal is translating away from the second direction.

According to a seventh aspect of the present disclosure, performing a gain control for the sound signals acquired by a part or all of the at least two sound collecting members according to the state information of the mobile terminal, includes:

increasing the gain of the sound signal acquired by a sound collecting member closer to a third direction among the at least two sound collecting members, when motion state information of the mobile terminal is rotating towards the third direction; or

decreasing the gain of the sound signal acquired by a sound collecting member closer to a fourth direction among the at least two sound collecting members, when the motion state information of the mobile terminal is rotating away from the fourth direction.

According to an eighth aspect of the present disclosure, processing the sound signals acquired by the at least two sound collecting members according to the state information of the mobile terminal, includes:

performing signal processing of the sound signals acquired by a part or all of the at least two sound collecting members according to the state information of the mobile terminal, to acquire a user's interested sound signal.

According to a ninth aspect of the present disclosure, a sound signal processing apparatus is provided, including:

an image acquiring unit, configured to acquire an image signal by using an image collecting member;

a sound acquiring unit, configured to acquire sound signals by using at least two sound collecting members;

a state acquiring unit, configured to acquire state information of a mobile terminal by using a state sensing member; and

an information processing unit, configured to process the sound signals acquired by the at least two sound collecting members according to the state information of the mobile terminal, when the image collecting member acquires the image signal.

According to a tenth aspect of the present disclosure, the information processing unit processes the sound signals acquired by the at least two sound collecting members independently from each other.

According to an eleventh aspect of the present disclosure, the state information of the mobile terminal includes translation information and/or rotation information.

According to a twelfth aspect of the present disclosure, the state sensing member is an accelerometer, and the state information acquired by the accelerometer includes linear acceleration information and/or angular acceleration information.

According to a thirteenth aspect of the present disclosure, the information processing unit is configured to perform a gain control for the sound signals acquired by a part or all of the at least two sound collecting members according to the state information of the mobile terminal.

According to a fourteenth aspect of the present disclosure, the information processing unit is specifically configured to:

increase the gain of the sound signal acquired by a sound collecting member closer to a first direction among the at least two sound collecting members, when motion state information of the mobile terminal is translating towards the first direction; or

decrease the gain of the sound signal acquired by a sound collecting member closer to a second direction among the at least two sound collecting members, when the motion state information of the mobile terminal is translating away from the second direction.

According to a fifteenth aspect of the present disclosure, the information processing unit is specifically configured to:

increase the gain of the sound signal acquired by a sound collecting member closer to a third direction among the at least two sound collecting members, when motion state information of the mobile terminal is rotating towards the third direction; or

decrease the gain of the sound signal acquired by a sound collecting member closer to a fourth direction among the at least two sound collecting members, when the motion state information of the mobile terminal is rotating away from the fourth direction.

According to a sixteenth aspect of the present disclosure, the information processing unit is configured to perform signal processing of the sound signals acquired by a part or all of the at least two sound collecting members according to the state information of the mobile terminal, to acquire a user's interested sound signal.

According to a seventeenth aspect of the present disclosure, a mobile terminal is provided, including:

an image collecting member, configured to collect an image signal;

at least two sound collecting members, configured to collect sound signals, respectively;

a state sensing member, configured to acquire state information of the mobile terminal;

a sound processor, configured to process the sound signals collected by the at least two sound collecting members; and

a controller, configured to control the sound processor to perform sound processing, according to the state information of the mobile terminal, when the image collecting member collects the image signal.

According to a eighteenth aspect of the present disclosure, there are two sound collecting members separately disposed on two sides of the mobile terminal, and the state sensing member is an accelerometer located on one side of the mobile terminal.

The embodiments of the present disclosure have the following beneficial effect: by processing the sound signals acquired by the at least two sound collecting members according to the state information of the mobile terminal, the sound signals from different sound collecting members can be controlled dynamically, thereby obtaining a good stereo shooting effect and improving the user's experiences.

The embodiments of the present disclosure are disclosed in details with reference to the following descriptions and drawings. It shall be appreciated that the scope of the embodiments of the present disclosure is not limited thereto, and the embodiments of the present disclosure include many changes, modifications and equivalents within the scope of the spirit and the clauses of the accompanied claims.

Features described and/or illustrated with respect to one embodiment can be used in one or more other embodiments in a same or similar way, and/or by being combined with or replacing the features in other embodiments.

To be noted, the term “comprise/include” used herein specifies the presence of feature, element, or component, not excluding the presence or addition of one or more other features, elements, or components or combinations thereof.

### BRIEF DESCRIPTION OF DRAWINGS

The above and other aspects, features and advantages of the embodiments of the present disclosure will be more obvious from the following detailed descriptions given with reference to the drawings, in which:

FIG. 1 is a flow diagram of a sound signal processing method according to an embodiment of the present disclosure;

FIG. 2 is another flow diagram of a sound signal processing method according to an embodiment of the present disclosure;

FIG. 3 is a structural diagram of a sound signal processing apparatus according to an embodiment of the present disclosure;

FIG. 4 is a structural diagram of a mobile terminal according to an embodiment of the present disclosure;

FIG. 5 is a schematic diagram of translating a mobile terminal according to an embodiment of the present disclosure;

FIG. 6 is a schematic diagram of rotating a mobile terminal according to an embodiment of the present disclosure;

FIG. 7 is another structural diagram of a mobile terminal according to an embodiment of the present disclosure; and

FIG. 8 is a block diagram of a system construction of a mobile terminal according to an embodiment of the present disclosure.

### DESCRIPTION OF EMBODIMENTS

The interchangeable terms “electronic device” and “electronic apparatus” include a portable radio communication device. The term “portable radio communication device”, which is hereinafter referred to as “mobile radio terminal”, “portable electronic apparatus”, or “portable communication apparatus”, includes all devices such as mobile phone, pager, communication apparatus, electronic organizer, personal digital assistant (PDA), smart phone, portable communication apparatus, etc.

In the present application, the embodiments of the present disclosure are mainly described with respect to a portable electronic apparatus in the form of a mobile phone (also referred to as “cellular phone”). However, it shall be appreciated that the present disclosure is not limited to the case of the mobile phone and it may relate to any type of appropriate electronic device, such as media player, gaming device, PDA and computer, digital camera, tablet PC, etc.

### Embodiment 1

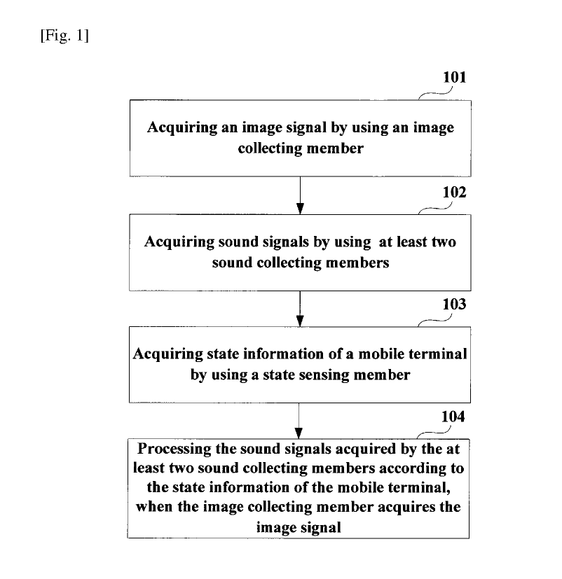

This embodiment of the present disclosure provides a sound signal processing method. FIG. 1 is a flow diagram of a sound signal processing method according to an embodiment of the present disclosure. As illustrated in FIG. 1, the sound signal processing method includes:

Step 101: acquiring an image signal by using an image collecting member;

Step 102: acquiring sound signals by using at least two sound collecting members;

Step 103: acquiring state information of a mobile terminal by using a state sensing member;

Step 104: processing the sound signals acquired by the at least two sound collecting members according to the state information of the mobile terminal, when the image collecting member acquires the image signal.

In this embodiment, the sound signal processing method may be applied to the mobile terminal. The mobile terminal for example may be, but not limited to, a mobile communication terminal, a picture camera, a video camera, a tablet PC, etc., or a wearable device else. Next, the descriptions are given by just taking the mobile communication terminal (cellular phone) as an example.

In this embodiment, the state information of the mobile terminal can be acquired by using the state sensing member, wherein the state information may be motion state information of the mobile terminal. But the present disclosure is not limited thereto, and the state information may also be information of the mobile terminal in a stationary state, such as stress state information after the mobile terminal is beaten (e.g., hit, tapped, struck, etc.) by the user, or deformation state information after the mobile terminal is gripped (e.g., grasped, held, squeezed, etc.) by the user.

In this embodiment, the image collecting member for example may be a camera, the sound collecting member for example may be a microphone, and the state sensing member for example may be an accelerometer. But the present disclosure is not limited thereto, for example, other sensors may also be adopted to acquire the motion state information of the mobile terminal. In addition, the state sensing member for example further may be a proximity sensor, a temperature sensor, a speed sensor, a barometric pressure sensor, a geomagnetic sensor, a deformation sensor, a humidity sensor and a light sensor.

In this embodiment, in step 104, the sound signals acquired by the at least two sound collecting members may be processed independently from each other according to the state information of the mobile terminal, thereby controlling the sound signals acquired by different sound collecting members, respectively, to obtain a better sound effect.

In this embodiment, the execution orders of steps 101 to 104 are not limited. For example, step 101 may be performed firstly, or step 102 or 103 may be performed initially, or steps 101 to 103 may be performed concurrently, and steps 101 and 104 can also be performed concurrently. The present disclosure is not limited thereto, and the specific manner can be determined according to the actual conditions.

In this embodiment, the motion state information of the mobile terminal may include translation information and/or rotation information. Thus, the shooting position or the shooting angle of the mobile terminal can be acquired through the state sensing member. In addition, the sound signals acquired by the at least two sound collecting members are processed independently from each other according to the motion state information of the mobile terminal, and independent controls of sound signals from different sound collecting members can be performed dynamically, thereby obtaining a good stereo shooting effect and improving the user's experiences.

Next, the present disclosure is described in details by taking the state sensing member as an example of an accelerometer. The motion state information acquired by the accelerometer includes linear acceleration information and/or angular acceleration information. The function of the accelerometer may be realized through a combination of the linear acceleration and the angular acceleration, or by the linear acceleration or the angular acceleration individually. Please refer to the related art for the specific technical content of the accelerometer.

In this embodiment, step 104 of processing the sound signals acquired by the at least two sound collecting members according to the state information of the mobile terminal may include: performing a gain control for the sound signals acquired by a part or all of the at least two sound collecting members according to the state information of the mobile terminal.

For example the gain (e.g., power or amplitude) of the sound signals acquired by one or several sound collecting members may be increased according to the motion state information of the mobile terminal, while no gain control is performed for the sound signals acquired by other sound collecting members. Alternatively, the gain of the sound signals acquired by one or several sound collecting members may be decreased, while no gain control is performed for the sound signals acquired by other sound collecting members.

To be noted, the above descriptions only relate to the gain control. But the present disclosure is not limited thereto, for example other processing, such as filtration, amplitude limitation and frequency response adjustment may be performed for the sound signals acquired by each sound collecting member. Any processing of the sound signals acquired by the at least two sound collecting members according to the state information of the mobile terminal shall fall within the scope of the embodiments of the present disclosure.

The embodiments of the present disclosure are described through an example where a gain control is performed by employing translation or rotation.

In one implementation, performing a gain control for the sound signals acquired by a part or all of the at least two sound collecting members according to the state information of the mobile terminal may include: increasing the gain of the sound signal acquired by a sound collecting member closer to a first direction among the at least two sound collecting members, when the motion state information of the mobile terminal is translating towards the first direction; or decreasing the gain of the sound signal acquired by a sound collecting member closer to a second direction among the at least two sound collecting members, when the motion state information of the mobile terminal is translating away from the second direction.

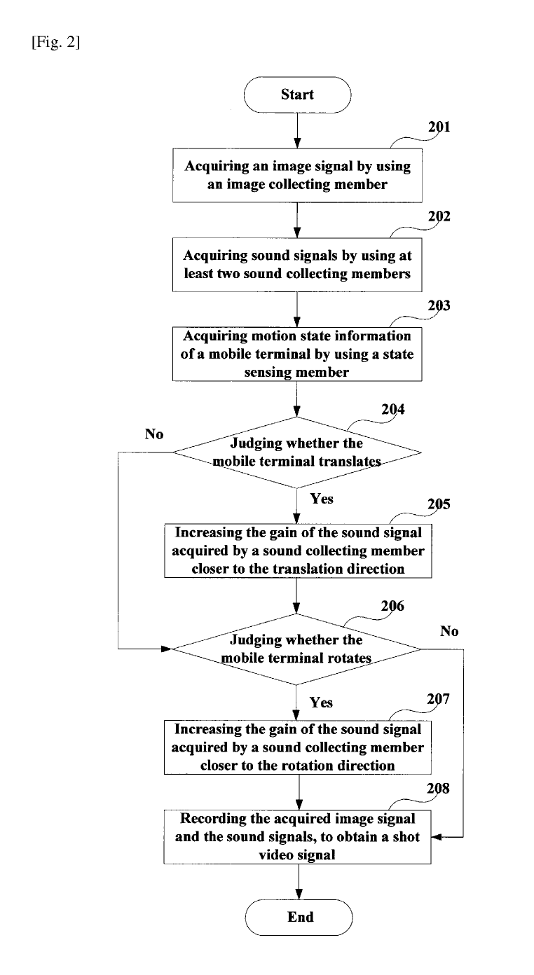

FIG. 2 is another flow diagram of a sound signal processing method according to an embodiment of the present disclosure. As illustrated in FIG. 2, the sound signal processing method includes:

Step 201: acquiring an image signal by using an image collecting member;

Step 202: acquiring sound signals by using at least two sound collecting members;

Step 203: acquiring motion state information of a mobile terminal by using a state sensing member;

Step 204: judging whether the mobile terminal translates according to the motion state information, and if the mobile terminal is in a translation state, performing step 205, otherwise performing step 206;

Step 205: increasing the gain of the sound signal acquired by a sound collecting member closer to the translation direction;

In this embodiment, if the mobile terminal translates leftwards, the gain of the sound signal acquired by a sound collecting member closer to the left side is increased; and if the mobile terminal translates rightwards, the gain of the sound signal acquired by a sound collecting member closer to the right side is increased.

Step 206: judging whether the mobile terminal rotates according to the motion state information, and if the mobile terminal is in a rotation state, performing step 207, otherwise performing step 208.

In this embodiment, the translation direction of the mobile terminal may be determined according to linear acceleration information of the accelerometer. For example, when the mobile terminal translates from left to right, the linear acceleration of the accelerometer in the direction of axis X is X axis>0, thus it can be determined that the mobile terminal moves from left to right. In addition, the rotation direction of the mobile terminal can be determined according to angular acceleration information of the accelerometer. For example, when the mobile terminal rotates leftwards, the angular acceleration of the accelerometer in the direction of axis Z is Z axis>0, thus it can be determined that the mobile terminal rotates leftwards. Please refer to related art for the usage of the accelerometer for judging the translation or rotation, which is omitted herein.

Step 207: increasing the gain of the sound signal acquired by a sound collecting member closer to the rotation direction.

In this embodiment, if the mobile terminal rotates leftwards, the gain of the sound signal acquired by a sound collecting member closer to the left side is increased, and if the mobile terminal rotates rightwards, the gain of the sound signal acquired by a sound collecting member closer to the right side is increased;

Step 208: recording the acquired image signal and the sound signals, to obtain a shot video signal.

To be noted, in the example illustrated in FIG. 2, the gain is controlled to be increased, but the present disclosure is not limited thereto, and for example the gain may be decreased. The sound collecting members on the left and right sides may be individually controlled, respectively. In addition, the above example describes the present disclosure only through the left and right directions, but the present disclosure is not limited thereto, and any other direction is allowed.

In addition, FIG. 2 only schematically illustrates the steps and their execution orders in this embodiment, but the present disclosure is not limited thereto. For example, steps 201 to 203 may be performed concurrently; or firstly, it may be judged whether a rotation is to be performed, and then it may be judged whether a translation is to be performed; or only a judgment of translation or rotation is performed. The steps and their execution orders may be determined according to the actual conditions.

The motion state in the present disclosure is described above by just taking translation and rotation as examples, but the present disclosure is not limited thereto. For example, the motion of the mobile terminal may be complex, and the mobile terminal may move in various directions of the entire space. A coordinate system may be set for the entire space, and the motion of the mobile terminal may be decomposed into combinations of translations and rotations, thereby obtaining the motion state information of the mobile terminal. Please refer to related art for the details.

In this embodiment, step 104 of processing the sound signals acquired by the at least two sound collecting members according to the state information of the mobile terminal may further include: performing signal processing of the sound signals acquired by a part or all of the at least two sound collecting members according to the state information of the mobile terminal, to acquire a user's interested sound signal.

For example, when detecting that the user enhances the grip of the left side of the mobile terminal, the deformation sensor may output the state information of the left deformation, and the mobile terminal may perform signal processing of the sound signal acquired by the microphone at the left side according to the state information. For example, high frequency portions of the sound at the left side are filtered and only low frequency portions thereof are reserved, so as to acquire the user's interested sound signal.

As can be seen from the above embodiment, by processing the sound signals acquired by the at least two sound collecting members according to the state information of the mobile terminal, the sound signals from different sound collecting members can be controlled dynamically, thereby obtaining a good stereo shooting effect and improving the user's experiences.

### Embodiment 2

This embodiment of the present disclosure provides a sound signal processing apparatus, which is disposed in a mobile terminal. This embodiment of the present disclosure is corresponding to the sound signal processing method in Embodiment 1, and the same contents are omitted herein.

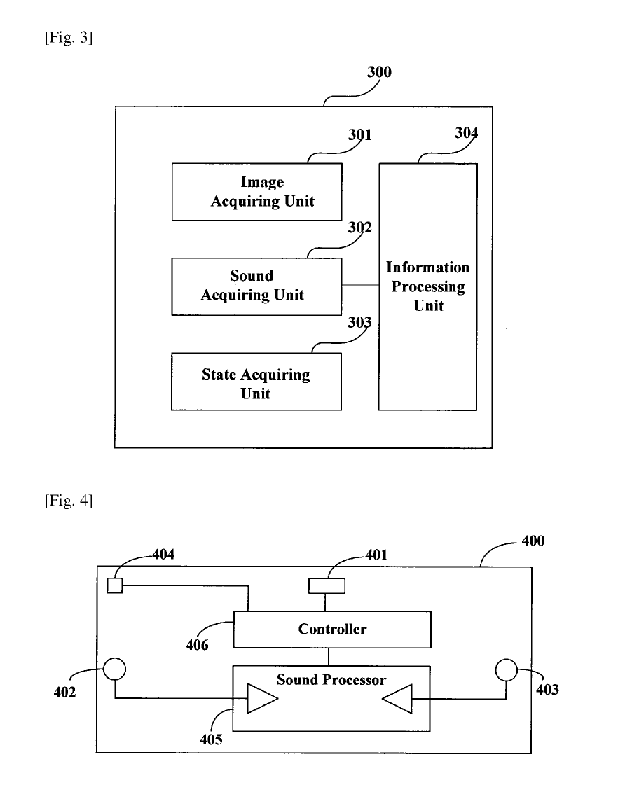

FIG. 3 is a structural diagram of a sound signal processing apparatus according to an embodiment of the present disclosure. As illustrated in FIG. 3, a sound signal processing apparatus 300 includes an image acquiring unit 301, a sound acquiring unit 302, a state acquiring unit 303 and an information processing unit 304.

The image acquiring unit 301 is configured to acquire an image signal by using an image collecting member; the sound acquiring unit 302 is configured to acquire sound signals by using at least two sound collecting members. The state acquiring unit 303 is configured to acquire state information of a mobile terminal by using a state sensing member. The information processing unit 304 is configured to process the sound signals acquired by the at least two sound collecting members according to the state information of the mobile terminal, when the image collecting member acquires the image signal.

In this embodiment, the information processing unit 304 may process the sound signals acquired by the at least two sound collecting members independently from each other. The state information of the mobile terminal may include translation information and/or rotation information.

In this embodiment, the state sensing member may be an accelerometer, and motion state information acquired by the accelerometer includes linear acceleration information and/or angular acceleration information, but the present disclosure is not limited thereto.

In this embodiment, the information processing unit 304 may be configured to perform a gain control for the sound signals acquired by a part or all of the at least two sound collecting members according to the state information of the mobile terminal.

In one implementation, the information processing unit 304 may be configured to: increase the gain of the sound signal acquired by a sound collecting member closer to a first direction among the at least two sound collecting members, when the motion state information of the mobile terminal is translating towards the first direction; or decrease the gain of the sound signal acquired by a sound collecting member closer to a second direction among the at least two sound collecting members, when the motion state information of the mobile terminal is translating away from the second direction.

In another implementation, the information processing unit 304 specifically may be configured to: increase the gain of the sound signal acquired by a sound collecting member closer to a third direction among the at least two sound collecting members, when the motion state information of the mobile terminal is rotating towards the third direction; or decrease the gain of the sound signal acquired by a sound collecting member closer to a fourth direction among the at least two sound collecting members, when the motion state information of the mobile terminal is rotating away from the fourth direction.

In this embodiment, the information processing unit 304 may be further configured to perform signal processing of the sound signals acquired by a part or all of the at least two sound collecting members according to the state information of the mobile terminal, to acquire a user's interested sound signal.

As can be seen from the above embodiment, by processing the sound signals acquired by the at least two sound collecting members according to the state information of the mobile terminal, the sound signals from different sound collecting members can be controlled dynamically, thereby obtaining a good stereo shooting effect and improving the user's experiences.

### Embodiment 3

This embodiment of the present disclosure provides a mobile terminal. In this embodiment, the mobile terminal may include the sound signal processing apparatus in Embodiment 2, and the contents thereof are incorporated herein, while the repetitions are omitted.

In this embodiment, the mobile terminal may be, but is not limited to, a cellular phone, a picture camera, a video camera, a tablet PC, or a wearable device.

FIG. 4 is a structural diagram of a mobile terminal according to an embodiment of the present disclosure, which illustrates an example of the mobile terminal. In order for simplicity, FIG. 4 only illustrates members related to the present disclosure, while other members of the mobile terminal are not illustrated and please refer to the related art.

As illustrated in FIG. 4, a mobile terminal 400 includes an image collecting member 401, at least two sound collecting members 402 and 403, a state sensing member 404, a sound processor 405 and a controller 406.

The image collecting member 401 is configured to collect an image signal. The at least two sound collecting members 402 and 403 are configured to collect sound signals, respectively. The state sensing member 404 is configured to acquire state information of the mobile terminal. The sound processor 405 is configured to process the sound signals collected by the at least two sound collecting members 402 and 403. The controller 406 is configured to control the sound processor 405 to perform sound processing, according to the state information of the mobile terminal, when the image collecting member 401 acquires the image signal.

As illustrated in FIG. 4, there may be two sound collecting members separately disposed on two sides of the mobile terminal; the state sensing member 404 may be an accelerometer located on one side of the mobile terminal. The sound processor 405, for example, may perform a control of increasing or decreasing the gain for the sound collecting members 402 and 403, respectively.

FIG. 5 is a schematic diagram of translating a mobile terminal according to an embodiment of the present disclosure. As illustrated in FIG. 5, the gain of the sound signal acquired by the sound collecting member 402 on the left side is increased, when the mobile terminal 400 translates from right to left (e.g., moving leftwards along axis X).

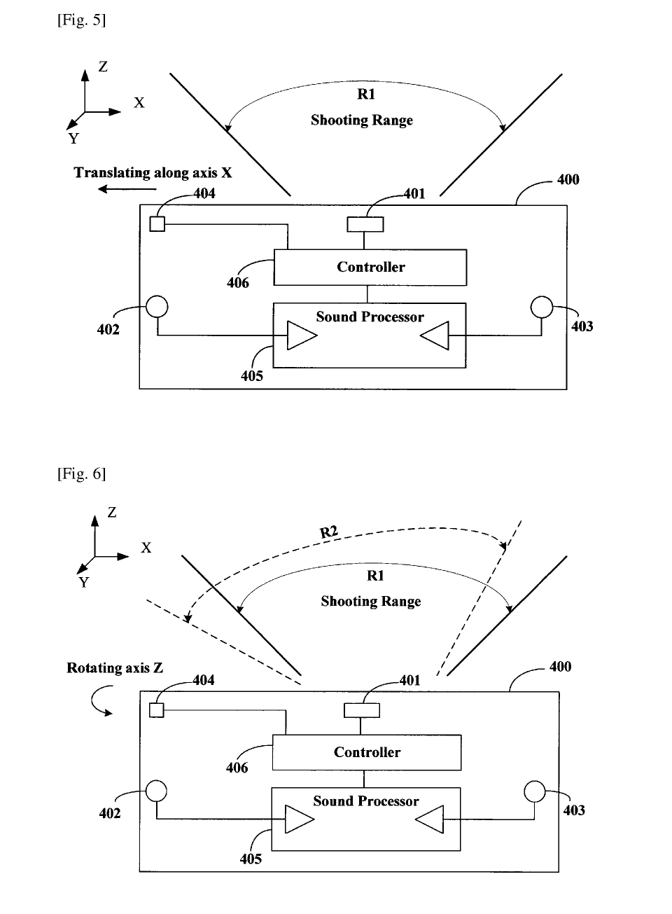

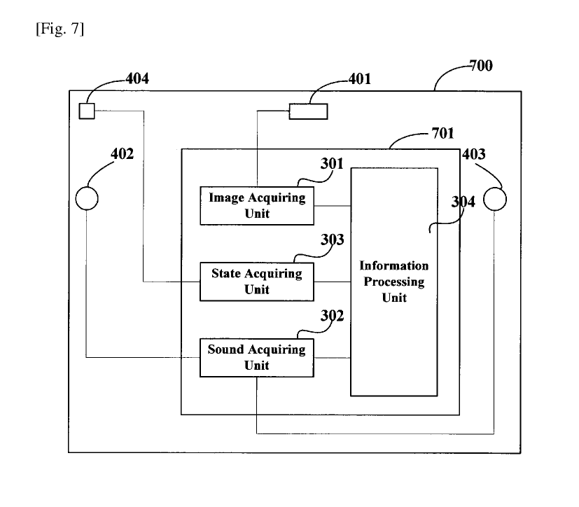

FIG. 6 is a schematic diagram of rotating a mobile terminal according to an embodiment of the present disclosure. As illustrated in FIG. 6, the gain of the sound signal acquired by the sound collecting member 402 on the left side is increased, when the mobile terminal 400 rotates leftwards (e.g., rotating around axis Z so that the shooting range of the camera moves leftwards).

In this embodiment, the functions of the sound signal processing apparatus 300 in Embodiment 2 may be configured in the sound processor 405 and the controller 406. In this embodiment the functions of the image acquiring unit 301, the sound acquiring unit 302 and the state acquiring unit 303 may be configured in the controller 406, while the function of the information processing unit 304 may be configured in the sound processor 405 and the controller 406.

FIG. 7 is another structural diagram of a mobile terminal according to an embodiment of the present disclosure, which illustrates an example of a mobile terminal 700. In this embodiment the functions of the sound processor 405 and the controller 406 are realized by a central controller 701. The central controller 701 may include various modules of the sound signal processing apparatus 300 in Embodiment 2.

The mobile terminal according to this embodiment of the present disclosure is described by taking the mobile communication terminal (cellular phone) as an example.

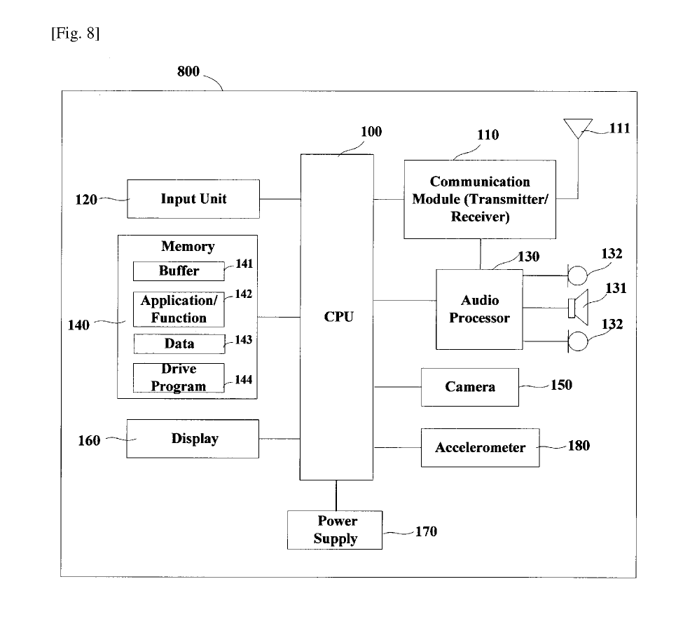

FIG. 8 is a block diagram of a system construction of a mobile terminal 800 according to an embodiment of the present disclosure. As illustrated in FIG. 8, the mobile terminal 800 may include a central processing unit (CPU) 100 and a memory 140 coupled to the CPU 100. To be noted, the diagram is exemplary, and other type of structure may also be used to supplement or replace the structure, so as to realize the telecom function or other function.

As illustrated in FIG. 8, the mobile terminal 800 may further include a camera 150 (image collecting member), at least two microphones 132 (sound collecting members) and an accelerometer 180 (state sensing member).

In one implementation, the function of sound signal processing may be integrated into the CPU 100, wherein the CPU 100 may be configured to carry out the sound signal processing method as described in Embodiment 1.

In another implementation, the sound signal processing apparatus 300 may be configured separately from the CPU 100. For example, the sound signal processing apparatus 300 may be configured as a chip connected to the CPU 100, thereby realizing the function of sound signal processing under the control of the CPU.

As illustrated in FIG. 8, the mobile terminal 800 may further include a communication module 110, an input unit 120, an audio processor 130, a display 160 and a power supply 170. To be noted, the mobile terminal 800 does not necessarily include all the members illustrated in FIG. 8. In addition, the mobile terminal 800 may also include other members not illustrated in FIG. 8, please refer to the prior art for the details.

As illustrated in FIG. 8, the CPU 100 sometimes is called as controller or operation control, including microprocessor or other processor device and/or logic device. The CPU 100 receives an input and controls the operations of respective members of the mobile terminal 800.

The memory 140, for example, may be one or more of a buffer, a flash memory, a hard disk drive, a removable medium, a volatile memory, a nonvolatile memory or other appropriate device. The memory may store information related to the failure, and a program for performing related information. In addition, the CPU 100 may execute the program stored in the memory 140 to realize the information storage or processing.

The input unit 120 provides an input to the CPU 100. The input unit 120 for example is a key or a touch input device. The camera 150 captures image data and supplies the captured image data to the CPU 100 for a conventional usage, such as storage, transmission, etc. The power supply 170 supplies electric power to the mobile terminal 800. The display 160 displays objects such as images and texts. The display may be, but not limited to, an LCD.

The memory 140 may be a solid state memory, such as Read Only Memory (ROM), Random Access Memory (RAM), SIM card, etc., or a memory which stores information even if the power is off, which can be selectively erased and provided with more data, and the example of such a memory is sometimes called as EPROM, etc. The memory 140 also may be a certain device of other type. The memory 140 includes a buffer memory 141 (sometimes called as buffer). The memory 140 may include an application/function storage section 142 which stores application programs and function programs or performs the operation procedure of the mobile terminal 800 via the CPU 100.

The memory 140 may further include a data storage section 143 which stores data such as contacts, digital data, pictures, sounds and/or any other data used by the electronic device. A drive program storage section 144 of the memory 140 may include various drive programs of the electronic device for performing the communication function and/or other functions (e.g., message transfer application, address book application, etc.) of the electronic device.

The communication module 110 is a transmitter/receiver 110 which transmits and receives signals via an antenna 111. The communication module (transmitter/receiver) 110 is coupled to the CPU 100, so as to provide an input signal and receive an output signal, which may be the same as the situation of the conventional mobile communication terminal

Based on different communication technologies, the same electronic device may be provided with a plurality of communication modules 110, such as cellular network module, Bluetooth module and/or wireless local area network (WLAN) module. The communication module (transmitter/receiver) 110 is further coupled to a speaker 131 and a microphone 132 via an audio processor 130, so as to provide an audio output via the speaker 131, and receive an audio input from the microphone 132, thereby performing the normal telecom function. The audio processor 130 may include any suitable buffer, decoder, amplifier, etc. In addition, the audio processor 130 is further coupled to the CPU 100, so as to locally record sound through the microphone 132, and play the locally stored sound through the speaker 131.

The embodiment of the present disclosure further provides a computer readable program, which when being executed in a mobile terminal, enables a computer to perform the sound signal processing method according to Embodiment 1 in the mobile terminal.

The embodiment of the present disclosure further provides a storage medium storing a computer readable program, wherein the computer readable program enables a computer to perform the sound signal processing method according to Embodiment 1 in a mobile terminal.

The preferred embodiments of the present disclosure are described as above with reference to the drawings. Many features and advantages of those embodiments are apparent from the detailed Specification, thus the accompanied claims intend to cover all such features and advantages of those embodiments which fall within the true spirit and scope thereof. In addition, since numerous modifications and changes are easily conceivable to a person skilled in the art, the embodiments of the present disclosure are not limited to the exact structures and operations as illustrated and described, but cover all suitable modifications and equivalents falling within the scope thereof.

It shall be understood that each part of the present disclosure may be implemented by hardware, software, firmware, or combinations thereof. In the above embodiments, multiple steps or methods may be implemented by software or firmware stored in the memory and executed by an appropriate instruction executing system. For example, if the implementation uses hardware, it may be realized by any one of the following technologies known in the art or combinations thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

Any process, method or block in the flowchart or described in other manners herein may be understood as being indicative of including one or more modules, segments or parts for realizing the codes of executable instructions of the steps in specific logic functions or processes, and that the scope of the preferred embodiments of the present disclosure include other implementations, wherein the functions may be executed in manners different from those shown or discussed (e.g., according to the related functions in a substantially simultaneous manner or in a reverse order), which shall be understood by a person skilled in the art.

The logic and/or steps shown in the flowcharts or described in other manners here may be, for example, understood as a sequencing list of executable instructions for realizing logic functions, which may be implemented in any computer readable medium, for use by an instruction executing system, apparatus or device (such as a system based on a computer, a system including a processor, or other systems capable of extracting instructions from an instruction executing system, apparatus or device and executing the instructions), or for use in combination with the instruction executing system, apparatus or device.

The above literal descriptions and drawings show various features of the present disclosure. It shall be understood that a person of ordinary skill in the art may prepare suitable computer codes to carry out each of the steps and processes described above and illustrated in the drawings. It shall also be understood that the above-described terminals, computers, servers, and networks, etc. may be any type, and the computer codes may be prepared according to the disclosure contained herein to carry out the present disclosure by using the apparatus.

Particular embodiments of the present disclosure have been disclosed herein. A person skilled in the art will readily recognize that the present disclosure is applicable in other environments. In practice, there exist many embodiments and implementations. The appended claims are by no means intended to limit the scope of the present disclosure to the above particular embodiments. Furthermore, any reference to “an apparatus configured to . . . ” is an explanation of apparatus plus function for describing elements and claims, and it is not desired that any element using no reference to “an apparatus configured to . . . ” is understood as an element of apparatus plus function, even though the wording of “apparatus” is included in that claim.

Although a particular preferred embodiment or embodiments have been shown and the present disclosure has been described, it is obvious that equivalent modifications and variants are conceivable to a person skilled in the art in reading and understanding the description and drawings. Especially for various functions executed by the above elements (parts, components, apparatus, and compositions, etc.), except otherwise specified, it is desirable that the terms (including the reference to “apparatus”) describing these elements correspond to any element executing particular functions of these elements (i.e. functional equivalents), even though the element is different from that executing the function of an exemplary embodiment or embodiments illustrated in the present disclosure with respect to structure. Furthermore, although the a particular feature of the present disclosure is described with respect to only one or more of the illustrated embodiments, such a feature may be combined with one or more other features of other embodiments as desired and in consideration of advantageous aspects of any given or particular application.

1. A sound signal processing method, comprising:
acquiring an image signal by using an image collecting member;
acquiring sound signals by using at least two sound collecting members;
acquiring state information of a mobile terminal by using a state sensing member; and
processing the sound signals acquired by the at least two sound collecting members according to the state information of the mobile terminal, when the image collecting member acquires the image signal.

2. The sound signal processing method according to claim 1, wherein the sound signals acquired by the at least two sound collecting members are processed independently from each other.

3. The sound signal processing method according to claim 1, wherein the state information of the mobile terminal comprises translation information and/or rotation information.

4. The sound signal processing method according to claim 1, wherein the state sensing member is an accelerometer, and motion state information acquired by the accelerometer comprises linear acceleration information and/or angular acceleration information.

5. The sound signal processing method according to claim 1, wherein processing the sound signals acquired by the at least two sound collecting members according to the state information of the mobile terminal, comprises:
performing a gain control for the sound signals acquired by a part or all of the at least two sound collecting members according to the state information of the mobile terminal.

6. The sound signal processing method according to claim 5, wherein performing a gain control for the sound signals acquired by a part or all of the at least two sound collecting members according to the state information of the mobile terminal, comprises:
increasing the gain of the sound signal acquired by a sound collecting member closer to a first direction among the at least two sound collecting members, when motion state information of the mobile terminal is translating towards the first direction; or
decreasing the gain of the sound signal acquired by a sound collecting member closer to a second direction among the at least two sound collecting members, when the motion state information of the mobile terminal is translating away from the second direction.

7. The sound signal processing method according to claim 5, wherein performing a gain control for the sound signals acquired by a part or all of the at least two sound collecting members according to the state information of the mobile terminal, comprises:
increasing the gain of the sound signal acquired by a sound collecting member closer to a third direction among the at least two sound collecting members, when motion state information of the mobile terminal is rotating towards the third direction; or
decreasing the gain of the sound signal acquired by a sound collecting member closer to a fourth direction among the at least two sound collecting members, when the motion state information of the mobile terminal is rotating away from the fourth direction.

8. The sound signal processing method according to claim 1, wherein processing the sound signals acquired by the at least two sound collecting members according to the state information of the mobile terminal, comprises:
performing signal processing of the sound signals acquired by a part or all of the at least two sound collecting members according to the state information of the mobile terminal, to acquire a user's interested sound signal.

9. A sound signal processing apparatus, comprising:
an image acquiring unit, configured to acquire an image signal by using an image collecting member;
a sound acquiring unit, configured to acquire sound signals by using at least two sound collecting members;
a state acquiring unit, configured to acquire state information of a mobile terminal by using a state sensing member; and
an information processing unit, configured to process the sound signals acquired by the at least two sound collecting members according to the state information of the mobile terminal, when the image collecting member acquires the image signal.

10. The sound signal processing apparatus according to claim 9, wherein the information processing unit is configured to process the sound signals acquired by the at least two sound collecting members independently from each other.

11. The sound signal processing apparatus according to claim 9, wherein the state information of the mobile terminal comprises translation information and/or rotation information.

12. The sound signal processing apparatus according to claim 9, wherein the state sensing member is an accelerometer, and
motion state information acquired by the accelerometer comprises linear acceleration information and/or angular acceleration information.

13. The sound signal processing apparatus according to claim 9, wherein the information processing unit is configured to perform a gain control for the sound signals acquired by a part or all of the at least two sound collecting members according to the state information of the mobile terminal.

14. The sound signal processing apparatus according to claim 13, wherein the information processing unit is configured to:
increase the gain of the sound signal acquired by a sound collecting member closer to a first direction among the at least two sound collecting members, when motion state information of the mobile terminal is translating towards the first direction; or
decrease the gain of the sound signal acquired by a sound collecting member closer to a second direction among the at least two sound collecting members, when the motion state information of the mobile terminal is translating away from the second direction.

15. The sound signal processing apparatus according to claim 13, wherein the information processing unit is specifically configured to:
increase the gain of the sound signal acquired by a sound collecting member closer to a third direction among the at least two sound collecting members, when motion state information of the mobile terminal is rotating towards the third direction; or
decrease the gain of the sound signal acquired by a sound collecting member closer to a fourth direction among the at least two sound collecting members, when the motion state information of the mobile terminal is rotating away from the fourth direction.

16. The sound signal processing apparatus according to claim 9, wherein the information processing unit is configured to perform signal processing of the sound signals acquired by a part or all of the at least two sound collecting members according to the state information of the mobile terminal, to acquire a user's interested sound signal.

17. A mobile terminal, comprising:
an image collecting member, configured to collect an image signal;
at least two sound collecting members, configured to collect sound signals, respectively;
a state sensing member, configured to acquire state information of the mobile terminal;
a sound processor, configured to process the sound signals collected by the at least two sound collecting members; and
a controller, configured to control the sound processor to perform sound processing, according to the state information of the mobile terminal, when the image collecting member collects the image signal.

18. The mobile terminal according to claim 17, wherein there are two sound collecting members separately disposed on two sides of the mobile terminal, and the state sensing member is an accelerometer located on one side of the mobile terminal.

19. The sound signal processing apparatus according to claim 14, wherein the information processing unit is specifically configured to:
increase the gain of the sound signal acquired by a sound collecting member closer to a third direction among the at least two sound collecting members, when motion state information of the mobile terminal is rotating towards the third direction; or
decrease the gain of the sound signal acquired by a sound collecting member closer to a fourth direction among the at least two sound collecting members, when the motion state information of the mobile terminal is rotating away from the fourth direction.
